(19) United States
(12) Patent Application Publication
(10) Pub. No.: US 2025/0250400 A1
(43) Pub. Date: Aug. 7, 2025

(54) A PROCESS FOR RECYCLING POLYPROPYLENE FILMS

(71) Applicant: BOREALIS AG, Vienna (AT)

(72) Inventors: Jingbo Wang, Linz (AT); Markus Gahleitner, Linz (AT); Klaus Bernreitner, Linz (AT); Pauli Leskinen, Porvoo (FI); Peter Niedersüß, Linz (AT); Christian Goetzloff, Linz (AT)

(21) Appl. No.: 18/856,126

(22) PCT Filed: Apr. 25, 2023
(86) PCT No.: PCT/EP2023/060715

§ 371 Date: Oct. 11, 2024

(30) Foreign Application Priority Data
Apr. 26, 2022 (EP) 22170058.6

(51) Int. Cl. C08J 5/18; C08J 11/06

(52) U.S. Cl. CPC C08J 5/18; C08J 11/06; C08J 2323/12

(57) ABSTRACT

The present invention is directed to a process for forming a recycled polypropylene film, wherein a particular monolayer polypropylene film is recycled, a recycled polypropylene film obtainable therefrom, a use of the monolayer polypropylene film in a recycling process and a use of the recycled polypropylene composition in a film.

The present invention is directed to a process for forming a recycled polypropylene film, wherein a particular monolayer polypropylene film is recycled, a recycled polypropylene film obtainable therefrom, a use of the monolayer polypropylene film in a recycling process and a use of the recycled polypropylene composition in a film.

### BACKGROUND TO THE INVENTION

Polyolefins, in particular polyethylene and polypropylene are increasingly consumed in large amounts in a wide range of applications, including packaging for food and other goods, fibres, automotive components, and a great variety of manufactured articles.

Polypropylene based materials offer significant potential for mechanical recycling, as these materials are extensively used in packaging. Taking into account the huge amount of waste collected compared to the amount of waste recycled back into the stream, there is still a great potential for intelligent reuse of plastic waste streams and for mechanical recycling of plastic wastes.

If sufficient care is taken during the recycling process, it is possible to obtain recycled polyolefins having satisfactory mechanical properties that do not differ too much from the virgin materials. Alternatively, any degradation of the mechanical properties can be corrected through the addition of various modifier polyolefins.

Although the mechanical properties can be corrected in this way, it is very difficult to improve the optical properties of recycled polyolefins, especially in the context of film applications.

As such, the development of polyolefin films that can be readily recycled without experiencing a significant degradation of the optical properties represents a significant development.

### SUMMARY OF THE INVENTION

Accordingly, the present inventors have discovered that certain monolayer polypropylene films that comprise a metallocene-catalysed polypropylene are far more easily recycled than similar films that comprise Ziegler-Natta-catalysed polypropylene, both in terms of the final optical properties of the recycled film and the energy requirements during the recycling process.

Therefore, the present invention is directed to a process for forming a recycled polypropylene film, comprising the steps of:
(a) providing a monolayer polypropylene film comprising at least 90 wt.-% of a random propylene copolymer (R-PP) based on the total weight of the monolayer polypropylene film having the following properties:
   i) a melt flow rate (MFR₂) measured according to ISO 1133 at 230° C. and 2.16 kg in the range from 2.0 to 20.0 g/10 min;
   ii) a melting temperature (Tₘ) measured by differential scanning calorimetry (DSC) in the range from 120 to 150° C.;
   iii) a total comonomer content, as determined by quantitative ¹³C-NMR spectroscopy analysis, in the range from 1.0 to 10.0 mol-%, wherein the comonomer is selected from the group consisting of ethylene and C₄ to C₈ alpha olefins and combinations thereof;
   iv) a content of 2,1-regiodefects, as determined by quantitative ¹³C-NMR spectroscopy analysis, in the range from 0.05 to 1.4 mol-%;
(b) mechanically recycling the film of step (a), thereby obtaining a recycled polypropylene composition; and
(c) extruding the recycled polypropylene composition of step (b) to form a recycled polypropylene film, preferably a recycled polypropylene cast film.

In a further embodiment, the present invention is directed to a recycled polypropylene film, comprising a recycled polypropylene composition having:
i) a melt flow rate (MFR₂) measured according to ISO 1333 at 230° C. and 2.16 kg in the range from 2.0 to 20.0 g/10 min;
ii) a melting temperature (Tₘ) measured by differential scanning calorimetry (DSC) in the range from 120 to 150° C.;
iii) a total comonomer content, as determined by quantitative ¹³C-NMR spectroscopy analysis, in the range from 1.0 to 10.0 mol-%, wherein the comonomer is selected from the group consisting of ethylene and C₄ to C₈ alpha olefins and combinations thereof; and
iv) a content of 2,1-regiodefects, as determined by quantitative ¹³C-NMR spectroscopy analysis, in the range from 0.05 to 1.4 mol-%;
   wherein the recycled polypropylene film has a gel index in the range from 16.0 to 50.0, as measured on a 70 μm film sample.

In another embodiment, the present invention is directed to a use of a monolayer polypropylene film comprising at least 90 wt.-% of a random propylene copolymer (R-PP), having the following properties:
i) a melt flow rate (MFR₂) measured according to ISO 1133 at 230° C. and 2.16 kg in the range from 2.0 to 20.0 g/10 min;
ii) a melting temperature (Tₘ) measured by differential scanning calorimetry (DSC) in the range from 120 to 150° C.;
iii) a total comonomer content, as determined by quantitative ¹³C-NMR spectroscopy analysis, in the range from 1.0 to 10.0 mol-%, wherein the comonomer is selected from the group consisting of ethylene and C₄ to C₈ alpha olefins and combinations thereof;
iv) a content of 2,1-regiodefects, as determined by quantitative ¹³C-NMR spectroscopy analysis, in the range from 0.05 to 1.4 mol-%;
   to obtain a recycled polypropylene film having a gel index in the range from 16.0 to 50.0, as measured on a 70 μm film sample, wherein the recycled polypropylene film is obtained by mechanically recycling the monolayer polypropylene film.

In a final embodiment, the present invention is furthermore directed to a use of a recycled polypropylene composition having the following properties:
i) a melt flow rate (MFR₂) measured according to ISO 1133 at 230° C. and 2.16 kg in the range from 2.0 to 20.0 g/10 min;
ii) a melting temperature (Tₘ) measured by differential scanning calorimetry (DSC) in the range from 120 to 150° C.;
iii) a total comonomer content, as determined by quantitative ¹³C-NMR spectroscopy analysis, in the range from 1.0 to 10.0 mol-%, wherein the comonomer is selected from ethylene and C₄ to C₈ alpha olefins; and
iv) a content of 2,1-regiodefects, as determined by quantitative ¹³C-NMR spectroscopy analysis, in the range from 0.05 to 1.4 mol-%;
   in a film, preferably in a cast film.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

A propylene homopolymer is a polymer that essentially consists of propylene monomer units. Due to impurities especially during commercial polymerization processes, a propylene homopolymer can comprise up to 0.1 mol-% comonomer units, preferably up to 0.05 mol-% comonomer units and most preferably up to 0.01 mol-% comonomer units.

A propylene random copolymer is a copolymer of propylene monomer units and comonomer units, preferably selected from ethylene and C₄-C₈ alpha-olefins, in which the comonomer units are distributed randomly over the polymeric chain. The propylene random copolymer can comprise comonomer units from one or more comonomers different in their amounts of carbon atoms.

In the following amounts are given in % by weight (wt.-%) unless it is stated otherwise.

Typical for propylene homopolymers and propylene random copolymers is the presence of only one glass transition temperature.

### DETAILED DESCRIPTION

### The process

The process according to the present invention is a process for forming a recycled polypropylene film, comprising the steps of:
(a) providing a monolayer polypropylene film comprising at least 90 wt.-% of a random propylene copolymer (R-PP) having the following properties:
   i) a melt flow rate (MFR₂) measured according to ISO 1333 at 230° C. and 2.16 kg in the range from 2.0 to 20.0 g/10 min;
   ii) a melting temperature (Tₘ) measured by differential scanning calorimetry (DSC) in the range from 120 to 150° C.;
   iii) a total comonomer content, as determined by quantitative ¹³C-NMR spectroscopy analysis, in the range from 1.0 to 10.0 mol-%, wherein the comonomer is selected from the group consisting of ethylene and C₄ to C₈ alpha olefins and combinations thereof;
   iv) a content of 2,1-regiodefects, as determined by quantitative ¹³C-NMR spectroscopy analysis, in the range from 0.05 to 1.4 mol-%;
(b) mechanically recycling the film of step (a), thereby obtaining a recycled polypropylene composition; and
(c) extruding the recycled polypropylene composition of step (b) to form a recycled polypropylene film, preferably a recycled polypropylene cast film.

The mechanical recycling of step (b) may be any mechanical recycling process known in the art; however, it is preferred that the mechanical recycling of step (b) is carried out in a continuous melt-mixing device, preferably at a temperature in the range from 170 to 270° C., more preferably in the range from 180 to 260° C., most preferably in the range from 185 to 230° C.

The extrusion of step (c) may be any extrusion process known to the person skilled in the art suitable for producing a recycled polypropylene film, preferably a recycled polypropylene cast film. Machinery designed for carrying out such extrusion processes (i.e. extruders) are well-known in the art. The temperature of the melt during such film extrusions may be in the range from 200 to 290° C.

### The Monolayer Polypropylene Film

The selection of the monolayer polypropylene film is the key factor underlying the present invention.

The monolayer polypropylene film according to the present invention comprises at least 90 wt.-%, more preferably at least 95 wt.-%, yet more preferably at least 98 wt.-% of the random propylene copolymer (R-PP).

In one embodiment, the monolayer polypropylene film essentially consists of the random propylene copolymer (R-PP).

The monolayer polypropylene film of the present invention may comprise further components. However, it is preferred that the inventive monolayer polypropylene film comprises as polymer components only the random propylene copolymer (R-PP), as defined below. Accordingly, the amount of random propylene copolymer (R-PP1), may not result in 100.0 wt.-% based on the total weight of the monolayer polypropylene film. Thus, the remaining part up to 100.0 wt.-% of the total weight of the monolayer polypropylene film may be accomplished by further additives known in the art. However, this remaining part shall be not more than 10.0 wt.-%, preferably not more than 5.0 wt.-%, yet more preferably not more than 3.0 wt.-% within the monolayer polypropylene film. For instance, the monolayer polypropylene film may comprise additionally small amounts of additives selected from the group consisting of antioxidants, stabilizers, fillers, colorants, nucleating agents and antistatic agents. In general, they are incorporated during granulation of the pulverulent product obtained in the polymerization.

In case the monolayer polypropylene film comprises an α-nucleating agent, it is preferred that it is free of β-nucleating agents. The α-nucleating agent is preferably selected from the group consisting of
(i) salts of monocarboxylic acids and polycarboxylic acids, e.g. sodium benzoate or aluminum tert-butylbenzoate, and
(ii) dibenzylidenesorbitol (e.g. 1,3:2,4 dibenzylidenesorbitol) and C₁-C₈-alkyl-substituted dibenzylidenesorbitol derivatives, such as methyldibenzylidenesorbitol, ethyldibenzylidenesorbitol or dimethyldibenzylidenesorbitol (e.g. 1,3:2,4 di(methylbenzylidene) sorbitol), or substituted nonitol-derivatives, such as 1,2,3,-trideoxy-4,6:5, 7-bis-O-[(4-propylphenyl)methylene]-nonitol, and
(iii) salts of diesters of phosphoric acid, e.g. sodium 2,2′-methylenebis (4,6,-di-tert-butylphenyl) phosphate or aluminium-hydroxy-bis[2,2′-methylene-bis(4,6-di-t-butylphenyl)phosphate], and
(iv) vinylcycloalkane polymer and vinylalkane polymer (as discussed in more detail below), and
(v) mixtures thereof.

Such additives are generally commercially available and are described, for example, in “Plastic Additives Handbook”, pages 871 to 873, 5th edition, 2001 of Hans Zweifel.

It is preferred that monolayer polypropylene film has a gel index in the range from 0.0 to less than 16.0, more preferably in the range from 2.0 to less than 16.0, yet more preferably in the range from 6.0 to less than 16.0, most preferably in the range from 10.0 to less than 16.0.

It is also preferred that the monolayer polypropylene film has a thickness in the range from 1 to 200 μm, more preferably in the range from 5 to 180 μm, yet more preferably in the range from 10 to 160 μm, most preferably in the range from 20 to 130 μm.

### The Random Propylene Copolymer (R-PP)

The major component present in the monolayer polypropylene film is the random propylene copolymer (R-PP), which is present in an amount of at least 90 wt.-%.

The random propylene copolymer (R-PP) has a melt flow rate (MFR₂), measured according to ISO 1333 at 230° C. and 2.16 kg, in the range from 2.0 to 20.0 g/10 min, more preferably in the range from 2.5 to 10.0 g/10 min, most preferably in the range from 3.0 to 7.0 g/10 min.

The random propylene copolymer (R-PP) preferably has a xylene cold soluble content (XCS), as determined according to ISO 16152, in the range from 5 to 25 wt.-%, more preferably in the range from 10 to 20 wt.-%, most preferably in the range from 12 to 18 wt.-%.

The random propylene copolymer (R-PP) preferably has a molecular weight distribution (Mz/Mw), as determined by gel permeation chromatography (GPC), in the range from 1.10 to 2.10, more preferably in the range from 1.30 to 2.00, most preferably in the range from 1.50 to 1.90.

The random propylene copolymer (R-PP) preferably has a weight average molecular weight (Mw), as determined by gel permeation chromatography (GPC), in the range from 200 to 300 kg/mol, more preferably in the range from 220 to 280 kg/mol, most preferably in the range from 240 to 260 kg/mol.

The random propylene copolymer (R-PP) preferably has a size average molecular weight (Mz), as determined by gel permeation chromatography (GPC), in the range from 400 to 500 kg/mol, more preferably in the range from 420 to 480 kg/mol, most preferably in the range from 440 to 470 kg/mol.

The random propylene copolymer (R-PP) further has a melting temperature (Tₘ) measured by differential scanning calorimetry (DSC) in the range from 120 to 150° C., more preferably in the range from 122 to 148° C., most preferably in the range from 125 to 145° C.

The random propylene copolymer (R-PP) further has a total comonomer content, as determined by quantitative ¹³C-NMR spectroscopy analysis, in the range from 1.0 to 10.0 mol-%, more preferably in the range from 3.0 to 9.0 mol-%, most preferably in the range from 5.0 to 8.0 mol-%.

The comonomer(s) of the random propylene copolymer (R-PP) is/are selected from the group consisting of ethylene and C₄ to C₈ alpha olefins and combinations thereof.

It is particularly preferred that the random copolymer (R-PP) contains two comonomers, preferably wherein the first comonomer is ethylene and the second comonomer is selected from the group consisting of C₄ to C₈ alpha olefins, more preferably the first comonomer is ethylene and the second comonomer is 1-butene.

The random propylene copolymer (R-PP) further has a content of 2,1-regiodefects, as determined by quantitative ¹³C-NMR spectroscopy analysis, in the range from 0.05 to 1.4 mol-%, more preferably in the range from 0.10 to 1.2 mol-%, most preferably in the range from 0.20 to 0.90 mol-%.

The presence of 2,1-regiodefects in the random propylene copolymer (R-PP) is indicative that the random propylene copolymer (R-PP) has been polymerized in the presence of a single site catalyst (SSC).

It is therefore also preferred that the random propylene copolymer (R-PP) has been polymerized in the presence of a single site catalyst (SSC), more preferably a metallocene catalyst.

The term “2,1 regio defects” as used in the present invention defines the sum of 2,1-erythro regio-defects and 2,1-threo regio defects.

Propylene random copolymers having a number of regio-defects as required in the propylene composition of the invention are usually and preferably prepared in the presence of a single-site catalyst.

It is preferred that random propylene copolymer (R-PP) has a gel index, as measured on a 70 μm film sample, in the range from 0.0 to less than 16.0, more preferably in the range from 2.0 to less than 16.0, yet more preferably in the range from 6.0 to less than 16.0, most preferably in the range from 10.0 to less than 16.0.

It is further preferred that the random propylene copolymer (R-PP) is a multimodal random propylene copolymer, more preferably a bimodal random propylene copolymer.

Multimodality indicates that the random propylene copolymer (R-PP) contains two or more distinct fractions that differ in at least one property, most typically melt flow rate (MFR₂) or comonomer content.

It is thus preferred that the random propylene copolymer (R-PP) comprises:
(a) a first random propylene copolymer fraction (R-PP1) having a melt flow rate (MFR₂), measured according to ISO 1333 at 230° C. and 2.16 kg, in the range from 1.0 to 10.0 g/10 min, more preferably in the range from 1.3 to 5.0 g/10 min, most preferably in the range from 1.5 to 3.5 g/10 min; and
(b) a second random propylene copolymer fraction (R-PP2) having a melt flow rate (MFR₂) greater than that of the first random propylene copolymer fraction.

It is preferred that the weight ratio between the first random propylene copolymer fraction (R-PP1) and the second random propylene copolymer fraction (R-PP2), [(R-PP1):(R-PP2)] is in the range from 30:70 to 70:30, more preferably in the range from 33:67 to 60:40, most preferably in the range from 35:65 to 50:50.

It is furthermore preferred that the first random propylene copolymer fraction (R-PP1) and the random propylene copolymer (R-PP) together fulfil in equation (I):

$$1. \leq \frac{MFR ( R - PP )}{MFR ( R - PP 1 )} \leq 3.0 \qquad ( I )$$

wherein
MFR (R-PP) is the melt flow rate (MFR₂), measured according to ISO 1333 at 230° C. and 2.16 kg of the random propylene copolymer (R-PP), and
MFR (R-PP1) is the melt flow rate (MFR₂), measured according to ISO 1333 at 230° C. and 2.16 kg of the first random propylene copolymer fraction (R-PP1).

More preferably, the first random propylene copolymer fraction (R-PP1) and the random propylene copolymer (R-PP) together fulfil in equation (Ia):

$$1.3 \leq \frac{MFR ( R - PP )}{MFR ( R - PP 1 )} \leq 2.6 \qquad ( Ia )$$

Most preferably, the first random propylene copolymer fraction (R-PP1) and the random propylene copolymer (R-PP) together fulfil in equation (Ib):

$$1.6 \leq \frac{MFR ( R - PP )}{MFR ( R - PP 1 )} \leq 2.2 \qquad ( Ib )$$

### Process for Polymerizing the Random Propylene Copolymer (R-PP)

The process for the preparation of the random propylene copolymer (R-PP) is further described in detail below.

The random propylene copolymer (R-PP) is preferably produced in a sequential polymerization process.

The term “sequential polymerization system” indicates that the random propylene copolymer (R-PP) is produced in at least two reactors connected in series.

It is preferred that the random propylene copolymer (R-PP) has been prepared in a two reactor sequence, wherein the first reactor is a slurry reactor, more preferably a loop reactor, and the second reactor is a gas-phase reactor.

A preferred multistage process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479 or in WO 00/68315.

A further suitable slurry-gas phase process is the Spheripol® process of Basell.

Accordingly, the random propylene copolymer (R-PP) is preferably produced in a process comprising the following steps
(a) in the first polymerization reactor (R1), i.e. in a loop reactor (LR), propylene and one or more, preferably one or two different comonomer(s) selected from the group consisting of ethylene and C₄ to C₈ alpha olefins, more preferably ethylene and/or 1-butene is polymerized obtaining a first random propylene copolymer fraction (R-PP1),
(b) transferring said first random propylene copolymer fraction (R-PP1) to a second polymerization reactor (R2),
(c) in the second polymerization reactor (R2) propylene and one or more, preferably one or two different comonomer(s) selected from the group consisting of ethylene and C₄ to C₈ alpha olefins, more preferably ethylene and/or 1-butene is polymerized in the presence of the first random propylene copolymer fraction (R-PP1) obtaining a second random propylene copolymer fraction (R-PP2), said first random propylene copolymer fraction (R-PP1) and said second first random propylene copolymer fraction (R-PP2) form the random propylene copolymer (R-PP).

A pre-polymerization as described above can be accomplished prior to step (a).

As pointed out above, in the specific process for the preparation of the random propylene copolymer (R-PP) as defined above a single site catalyst (SSC) should be used. Accordingly, the single site catalyst (SSC) will be now described in more detail.

The single site catalyst according to the present invention may be any supported metallocene catalyst suitable for the production of highly isotactic polypropylene.

It is preferred that the single site catalyst (SSC) comprises a metallocene complex, a co-catalyst system comprising a boron-containing co-catalyst and/or aluminoxane co-catalyst, and a silica support.

Preferred complexes of the metallocene catalyst include:
rac-dimethylsilanediylbis[2-methyl-4-(3′,5′-dimethylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl] zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl] zirconium dichloride,
rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

Especially preferred is rac-anti-dimethylsilanediyl[2-methyl-4,8-bis-(3′,5′-dimethylphenyl)-1,5,6,7-tetrahydro-s indacen-1-yl][2-methyl-4-(3′,5′-dimethylphenyl)-5-methoxy-6-tertbutylinden-1-yl] zirconium dichloride (II)

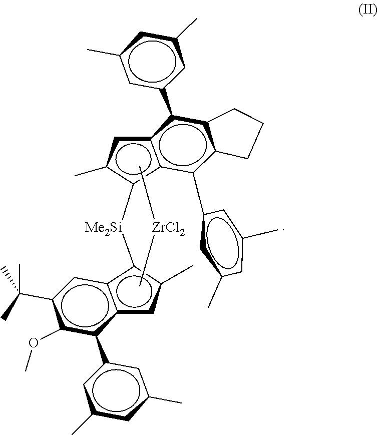

The ligands required to form the complexes and hence catalysts of the invention can be synthesised by any process and the skilled organic chemist would be able to devise various synthetic protocols for the manufacture of the necessary ligand materials. For Example WO2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959, in which the most preferred catalyst of the present invention is described.

According to the present invention a co-catalyst system comprising a boron containing co-catalyst and/or an aluminoxane co-catalyst is used in combination with the above defined metallocene catalyst complex.

The preferred co-catalysts are aluminoxanes, more preferably methylaluminoxanes, combinations of aluminoxanes with Al-alkyls, boron or borate co-catalysts, and combination of aluminoxanes with boron-based co-catalysts.

The catalyst can be used in supported or unsupported form, preferably in supported form. The particulate support material used is preferably an organic or inorganic material, such as silica, alumina or zirconia or a mixed oxide such as silica-alumina, in particular silica, alumina or silica-alumina. The use of a silica support is preferred. The person skilled in the art is aware of the procedures required to support a metallocene catalyst.

The use of these supports is routine in the art.

### The Recycled Polypropylene Composition and Film

The recycled polypropylene composition obtained in step (b) and the recycled polypropylene film obtained in step (c) may also be defined in terms of the mechanical and optical properties, both in terms of their absolute values and in terms of their values relative to those of the random propylene copolymer (R-PP) and/or the monolayer polypropylene film.

Indeed, it is preferred that the ratio of the MFR₂ of the recycled polypropylene composition obtained in step (b) to the MFR₂ of the random propylene copolymer (R-PP) of the monolayer polypropylene film provided in step (a), [MFR₂(B)/MFR₂(A)], is in the range from 1.00 to 1.30, more preferably in the range from 1.00 to 1.20, most preferably in the range from 1.00 to 1.15.

It is further preferred that the ratio of the xylene cold soluble content (XCS), as determined according to ISO 16152, of the recycled polypropylene composition obtained in step (b) to the xylene cold soluble content (XCS), as determined according to ISO 16152, of the random propylene copolymer (R-PP) of the monolayer polypropylene film provided in step (a), [XCS(B)/XCS(A)], is in the range from 1.00 to 1.30, more preferably in the range from 1.00 to 1.20, most preferably in the range from 1.00 to 1.10.

It is also preferred that the ratio of the weight average molecular weight (Mw), as determined by gel permeation chromatography (GPC), of the recycled polypropylene composition obtained in step (b) to the weight average molecular weight (Mw), as determined by gel permeation chromatography (GPC), of the random propylene copolymer (R-PP) of the monolayer polypropylene film provided in step (a), [Mw(B)/Mw(A)], is in the range from 0.90 to 1.00, more preferably in the range from 0.95 to 1.00, most preferably in the range from 0.97 to 1.00.

It is further preferred that the ratio of the size average molecular weight (Mz), as determined by gel permeation chromatography (GPC), of the recycled polypropylene composition obtained in step (b) to the size average molecular weight (Mz), as determined by gel permeation chromatography (GPC), of the random propylene copolymer (R-PP) of the monolayer polypropylene film provided in step (a), [Mz(B)/Mz(A)], is in the range from 0.90 to 1.00, more preferably in the range from 0.93 to 1.00, most preferably in the range from 0.96 to 1.00.

It is also preferred that the ratio of the molecular weight distribution (MWD, Mz/Mw), as determined by gel permeation chromatography (GPC), of the recycled polypropylene composition obtained in step (b) to the molecular weight distribution (MWD, Mz/Mw), as determined by gel permeation chromatography (GPC), of the random propylene copolymer (R-PP) of the monolayer polypropylene film provided in step (a), [MWD(B)/MWD(A)], is in the range from 0.90 to 1.00, more preferably in the range from 0.95 to 1.00, most preferably in the range from 0.98 to 1.00.

It is further preferred that the ratio of the gel index of the recycled polypropylene film obtained in step (c) to the gel index of the monolayer polypropylene film provided in step (a), [gel index(C)/gel index(A)], is in the range from 1.00 to 10.0, more preferably in the range from 1.00 to 5.0, most preferably in the range from 1.00 to 2.0.

The ratio of the gel index of the recycled polypropylene film obtained in step (c) to the gel index of the monolayer polypropylene film provided in step (a), [gel index(C)/gel index(A)], may further be in the range from 1.00 to 1.50, more preferably in the range from 1.00 to 1.30, most preferably in the range from 1.00 to 1.10.

Alternatively or additionally, it is preferred that the ratio of the gel index, as measured on a 70 μm cast film sample, of the recycled polypropylene composition obtained in step (b) to the gel index, as measured on a 70 μm cast film sample, of random propylene copolymer (R-PP) of the monolayer polypropylene film provided in step (a), [gel index(B)/gel index(A)], is in the range from 1.00 to 10.0, more preferably in the range from 1.00 to 5.0, most preferably in the range from 1.00 to 2.0.

The ratio of the gel index, as measured on a 70 μm cast film sample, of the recycled polypropylene composition obtained in step (b) to the gel index, as measured on a 70 μm cast film sample, of random propylene copolymer (R-PP) of the monolayer polypropylene film provided in step (a), [gel index(B)/gel index(A)], may further be in the range from 1.00 to 1.50, more preferably in the range from 1.00 to 1.30, most preferably in the range from 1.00 to 1.10.

In a separate embodiment, the present invention is directed to a recycled polypropylene film, comprising a recycled polypropylene composition having:
i) a melt flow rate (MFR₂) measured according to ISO 1333 at 230° C. and 2.16 kg in the range from 2.0 to 20.0 g/10 min;
ii) a melting temperature (Tₘ) measured by differential scanning calorimetry (DSC) in the range from 120 to 150° C.;
iii) a total comonomer content, as determined by quantitative ¹³C-NMR spectroscopy analysis, in the range from 1.0 to 10.0 mol-%, wherein the comonomer is selected from the group consisting of ethylene and C₄ to C₈ alpha olefins and combinations thereof; and
iv) a content of 2,1-regiodefects, as determined by quantitative ¹³C-NMR spectroscopy analysis, in the range from 0.05 to 1.4 mol-%;
   wherein the recycled polypropylene film has a gel index in the range from 16.0 to 50.0, as measured on a 70 μm film sample.

The recycled polypropylene composition has a melt flow rate (MFR₂), measured according to ISO 1333 at 230° C. and 2.16 kg, in the range from 2.0 to 20.0 g/10 min, more preferably in the range from 2.5 to 10.0 g/10 min, most preferably in the range from 3.0 to 7.0 g/10 min.

The recycled polypropylene composition preferably has a xylene cold soluble content (XCS), as determined according to ISO 16152, in the range from 5 to 25 wt.-%, more preferably in the range from 10 to 22 wt.-%, most preferably in the range from 13 to 19 wt.-%.

The recycled polypropylene composition preferably has a molecular weight distribution (Mz/Mw), as determined by gel permeation chromatography (GPC), in the range from 1.10 to 2.10, more preferably in the range from 1.30 to 2.00, most preferably in the range from 1.50 to 1.90.

The recycled polypropylene composition preferably has a weight average molecular weight (Mw), as determined by gel permeation chromatography (GPC), in the range from 200 to 300 kg/mol, more preferably in the range from 225 to 280 kg/mol, most preferably in the range from 240 to 260 kg/mol.

The recycled polypropylene composition preferably has a size average molecular weight (Mz), as determined by gel permeation chromatography (GPC), in the range from 400 to 500 kg/mol, more preferably in the range from 420 to 480 kg/mol, most preferably in the range from 430 to 460 kg/mol.

The recycled polypropylene composition further has a melting temperature (Tₘ) measured by differential scanning calorimetry (DSC) in the range from 120 to 150° C., more preferably in the range from 122 to 148° C., most preferably in the range from 125 to 145° C.

The recycled polypropylene composition further has a total comonomer content, as determined by quantitative ¹³C-NMR spectroscopy analysis, in the range from 1.0 to 10.0 mol-%, more preferably in the range from 3.0 to 9.0 mol-%, most preferably in the range from 5.0 to 8.0 mol-%.

The comonomer(s) of the recycled polypropylene composition is/are selected from the group consisting of ethylene and C₄ to C₈ alpha olefins and combinations thereof.

It is particularly preferred that the recycled polypropylene composition contains two comonomers, preferably wherein the first comonomer is ethylene and the second comonomer is selected from the group consisting of C₄ to C₈ alpha olefins, more preferably the first comonomer is ethylene and the second comonomer is 1-butene.

The recycled polypropylene composition further has a content of 2,1-regiodefects, as determined by quantitative ¹³C-NMR spectroscopy analysis, in the range from 0.05 to 1.4 mol-%, more preferably in the range from 0.10 to 1.2 mol-%, most preferably in the range from 0.20 to 0.9 mol-%.

The presence of 2,1-regiodefects in the recycled polypropylene composition is indicative that the material that has been recycled into the recycled polypropylene composition has been polymerized in the presence of a single site catalyst (SSC).

It is preferred that the recycled polypropylene composition has a gel index, as measured on a 70 μm film sample in the range from 16.0 to 50.0, more preferably in the range from 16.0 to 40.0, yet more preferably in the range from 16.0 to 30.0, most preferably in the range from 16.0 to 20.0.

The recycled polypropylene film has a gel index in the range from 16.0 to 50.0, more preferably in the range from 16.0 to 40.0, yet more preferably in the range from 16.0 to 30.0, most preferably in the range from 16.0 to 20.0.

It is preferred that the recycled polypropylene film is obtainable via, more preferably obtained by, the process as described above.

All preferable embodiments and fallback positions disclosed for the process as described above and for the uses as described below are applicable mutatis mutandis to the recycled polypropylene composition and the recycled polypropylene film.

### The Uses

The present invention is further directed to a use of the monolayer film of the invention.

The present invention is further directed to a use of a monolayer polypropylene film comprising at least 90 wt.-% of a random propylene copolymer (R-PP), having the following properties:
i) a melt flow rate (MFR₂) measured according to ISO 1133 at 230° C. and 2.16 kg in the range from 2.0 to 20.0 g/10 min;
ii) a melting temperature (Tₘ) measured by differential scanning calorimetry (DSC) in the range from 120 to 150° C.;
iii) a total comonomer content, as determined by quantitative ¹³C-NMR spectroscopy analysis, in the range from 1.0 to 10.0 mol-%, wherein the comonomer is selected from the group consisting of ethylene and C₄ to C₈ alpha olefins and combinations thereof;
iv) a content of 2,1-regiodefects, as determined by quantitative ¹³C-NMR spectroscopy analysis, in the range from 0.05 to 1.4 mol-%;
   to obtain a recycled polypropylene film having a gel index in the range from 16.0 to 50.0, as measured on a 70 μm film sample, wherein the recycled polypropylene film is obtained by mechanically recycling the monolayer polypropylene film.

A use of a recycled polypropylene composition having the following properties:
i) a melt flow rate (MFR₂) measured according to ISO 1133 at 230° C. and 2.16 kg in the range from 2.0 to 20.0 g/10 min;
ii) a melting temperature (Tₘ) measured by differential scanning calorimetry (DSC) in the range from 120 to 150° C.;
iii) a total comonomer content, as determined by quantitative ¹³C-NMR spectroscopy analysis, in the range from 1.0 to 10.0 mol-%, wherein the comonomer is selected from ethylene and C₄ to C₈ alpha olefins; and
iv) a content of 2,1-regiodefects, as determined by quantitative ¹³C-NMR spectroscopy analysis, in the range from 0.05 to 1.4 mol-%;
   in a film, preferably in a cast film.

All preferable embodiments and fallback positions of the monolayer polypropylene film, the random propylene copolymer (R-PP), the recycled polypropylene composition, the recycled polypropylene film and the process of the present invention, as described above, are applicable mutatis mutandis to the uses of the present invention.

The invention will now be described with reference to the following non-limiting examples.

### EXAMPLES

### A. Measuring Methods

The following definitions of terms and determination methods apply for the above general description of the invention including the claims as well as to the below examples unless otherwise defined.

### Melting Temperature Tₘ, Melting Enthalpy Hₘ and Crystallization Temperature T_{c}

The parameters were determined with a TA Instrument Q2000 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (T_{c}) is determined from the cooling step, while melting temperature (Tₘ) and melting enthalpy (Hₘ) are determined from the second heating step. Melting and crystallization temperatures were taken as the peaks of endotherms and exotherms.

### Quantification of Microstructure by NMR Spectroscopy

Quantitative nuclear-magnetic resonance (NMR) spectroscopy was used to quantify the isotacticity and regio-regularity of the propylene polymers.

Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics.

For propylene homopolymers approximately 200 mg of material was dissolved in 1,2-tetrachloroethane-d₂ (TCE-d₂). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution needed for tacticity distribution quantification (Busico, V., Cipullo, R., Prog. Polym. Sci. 26 (2001) 443; Busico, V.; Cipullo, R., Monaco, G., Vacatello, M., Segre, A. L., Macromolecules 30 (1997) 6251). Standard single-pulse excitation was employed utilising the NOE and bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 11289). A total of 8192 (8 k) transients were acquired per spectra.

Quantitative ¹³C{¹H} NMR spectra were processed, integrated and relevant quantitative properties determined from the integrals using proprietary computer programs. For propylene homopolymers all chemical shifts are internally referenced to the methyl isotactic pentad (mmmm) at 21.85 ppm.

Characteristic signals corresponding to regio defects (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) or comonomer were observed.

The tacticity distribution was quantified through integration of the methyl region between 23.6-19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromolecules 30 (1997) 6251).

Specifically the influence of regio-defects and comonomer on the quantification of the tacticity distribution was corrected for by subtraction of representative regio-defect and comonomer integrals from the specific integral regions of the stereo sequences.

The isotacticity was determined at the pentad level and reported as the percentage of isotactic pentad (mmmm) sequences with respect to all pentad sequences:

$$[ mmmm ] \% = 100 * ( mmmm / sum of all pentads )$$

The presence of 2,1 erythro regio-defects was indicated by the presence of the two methyl sites at 17.7 and 17.2 ppm and confirmed by other characteristic sites. Characteristic signals corresponding to other types of regio-defects were not observed (Resconi, L., Cavallo, L., Fait, A., Piemontesi, F., Chem. Rev. 2000, 100, 1253).

The amount of 2,1 erythro regio-defects was quantified using the average integral of the two characteristic methyl sites at 17.7 and 17.2 ppm:

$${P}_{21 e} = ( {I}_{e 6} + {I}_{e 8} ) / 2$$

The amount of 1,2 primary inserted propene was quantified based on the methyl region with correction undertaken for sites included in this region not related to primary insertion and for primary insertion sites excluded from this region:

$${P}_{12} = {I}_{CH 3} + {P}_{12 e}$$

The total amount of propene was quantified as the sum of primary inserted propene and all other present regio-defects:

$${P}_{total} = {P}_{12} + {P}_{21 e}$$

The mole percent of 2,1 erythro regio-defects was quantified with respect to all propene:

$$[ 21 e ] mol \% = 100 * ( {P}_{21 e} / {P}_{total} )$$

### Comonomer Content

### Quantification of Microstructure by NMR Spectroscopy

### For Ethylene-Propylene Copolymer

Quantitative nuclear-magnetic resonance (NMR) spectroscopy was further used to quantify the comonomer content and comonomer sequence distribution of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S β β + S β γ + S βδ + 0.5 ( S αβ + S α γ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### For Propylene-Ethylene-Butene Terpolymer

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilising the NOE at short recycle delays of 3 s {pollard04, klimke06} and the RS-HEPT decoupling scheme {fillip05,griffin07}. A total of 1024 (1 k) transients were acquired per spectra.

Quantitative ¹³C{¹H} NMR spectra were processed, integrated and relevant quantitative properties determined from the integrals. All chemical shifts are internally referenced to the methyl isotactic pentad (mmmm) at 21.85 ppm.

Characteristic signals corresponding to the incorporation of 1-butene were observed {brandolini01} and the comonomer content quantified.

The amount of isolated 1-butene incorporated in PBP sequences was quantified using the integral of the αB2 sites at 43.6 ppm accounting for the number of reporting sites per comonomer:

$$B = {I}_{α B 2} / 2$$

The amount of consecutively incorporated 1-butene in PBBP sequences was quantified using the integral of the ααB2B2 site at 40.5 ppm accounting for the number of reporting sites per comonomer:

$$BB = 2 * {I}_{α α B 2 B 2}$$

In presence of BB the value of B must be corrected for the influence of the αB2 sites resulting from BB:

$$B = ( {I}_{α B 2} / 2 ) - BB / 2$$

The total 1-butene content was calculated based on the sum of isolated and consecutively incorporated 1-butene:

$${B}_{total} = B + BB$$

Characteristic signals corresponding to the incorporation of ethylene were observed {brandolini01} and the comonomer content quantified.

The amount of isolated ethylene incorporated in PEP sequences was quantified using the integral of the Sββ sites at 24.3 ppm accounting for the number of reporting sites per comonomer:

E=I_{Sββ}

If characteristic signals corresponding to consecutive incorporation of ethylene in PEE sequence was observed the Sβδ site at 27.0 ppm was used for quantification:

EE=I_{Sβδ}

Characteristic signals corresponding to regio defects were observed {resconi00}. The presence of isolated 2,1-erythro regio defects was indicated by the presence of the two methyl sites at 17.7 and 17.2 ppm, by the methylene site at 42.4 ppm and confirmed by other characteristic sites. The presence of 2,1 regio defect adjacent an ethylene unit was indicated by the two inequivalent Sαβ signals at 34.8 ppm and 34.4 ppm respectively and the Tγγ at 33.7 ppm.

The amount of isolated 2,1-erythro regio defects (P₂₁ₑ isolated) was quantified using the integral of the methylene site at 42.4 ppm (Iₑ₉):

P₂₁ₑ isolated=Iₑ₉

If present the amount of 2,1 regio defect adjacent to ethylene (P_{E21}) was quantified using the methine site at 33.7 ppm (I_{Tγγ}):

P_{E21}=I_{Tγγ}

The total ethylene content was then calculated based on the sum of ethylene from isolated, consecutively incorporated and adjacent to 2,1 regio defects:

$${E}_{total} = E + EE + {P}_{E 21}$$

The amount of propene was quantified based on the Sαα methylene sites at 46.7 ppm including all additional propene units not covered by Sαα e.g. the factor 3*P₂₁ₑ isolated accounts for the three missing propene units from isolated 2,1-erythro regio defects:

$${P}_{total} = {I}_{S α α} + 3 * {P}_{21 e isolated} + B + 0.5 * BB + E + 0.5 * EE + 2 * {P}_{E 21}$$

The total mole fraction of 1-butene and ethylene in the polymer was then calculated as:

$$fB = {B}_{total} / ( {E}_{total} + {P}_{total} + {B}_{total} ) \\ \\ \\ fE = {E}_{total} / ( {t}_{total} + {P}_{total} + {B}_{total} )$$

The mole percent comonomer incorporation was calculated from the mole fractions:

$$B [ mol \% ] = 100 * fB \\ \\ \\ E [ mol \% ] = 100 * fE$$

The weight percent comonomer incorporation was calculated from the mole fractions:

$$B [ wt \% ] = 100 * ( fB * 56.11 ) / ( ( fE * 28.05 ) + ( fB * 56.11 ) + ( ( 1 - ( fE + fB ) ) * 42.08 ) ) \\ E [ wt \% ] = 100 * ( fE * 28.05 ) / ( ( fE * 28.05 ) + ( fB * 56.11 ) + ( ( 1 - ( fE + fB ) ) * 42.08 ) )$$

The mole percent of isolated 2,1-erythro regio defects was quantified with respect to all propene:

$$[ 21 e ] mol \% = 100 * {P}_{21 e isolated} / {P}_{total}$$

The mole percent of 2, 1 regio defects adjacent to ethylene was quantified with respect to all propene:

$$[ E 21 ] mol \% = 100 * {P}_{E 21} / {P}_{total}$$

The total amount of 2,1 defects was quantified as following:

$$[ 21 ] mol \% = [ 21 e ] + [ E 21 ]$$

Characteristic signals corresponding to other types of regio defects (2,1-threo, 3,1 insertion) were not observed {resconi00}.

klimke06: Klimke, K., Parkinson, M., Piel, C., Kaminsky, W., Spiess, H. W., Wilhelm, M., Macromol. Chem. Phys. 2006;207:382.

parkinson07: Parkinson, M., Klimke, K., Spiess, H. W., Wilhelm, M., Macromol. Chem. Phys. 2007;208:2128.

pollard04: Pollard, M., Klimke, K., Graf, R., Spiess, H. W., Wilhelm, M., Sperber, O., Piel, C., Kaminsky, W., Macromolecules 2004;37:813.

filip05: Filip, X., Tripon, C., Filip, C., J. Mag. Resn. 2005, 176, 239

griffin07: Griffin, J. M., Tripon, C., Samoson, A., Filip, C., and Brown, S. P., Mag. Res. in Chem. 2007 45, S1, S198

castignolles09: Castignolles, P., Graf, R., Parkinson, M., Wilhelm, M., Gaborieau, M., Polymer 50 (2009) 2373

resconi00: Resconi, L., Cavallo, L., Fait, A., Piemontesi, F., Chem. Rev. 2000, 100, 1253

brandolini01: A. J. Brandolini, D. D. Hills, “NMR spectra of polymers and polymer additives”, Marcel Deker Inc., 2000

### Melt Flow Rate

The melt flow rate (MFR) was determined according to ISO 1133—Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR₂ of polypropylene is determined at a temperature of 230° C. and a load of 2.16 kg.

### Number Average Molecular Weight (Mn), Weight Average Molecular Weight (Mw), Size Average Molecular Weight, and Molecular Weight Distribution (MWD)

Molecular weight averages (Mz, Mw, Mn), and the molecular weight distribution (MWD), i.e. the Mz/Mw (wherein Mz is the size average molecular weight and Mw is the weight average molecular weight), were determined by Gel Permeation.

Chromatography (GPC) according to ISO 16014-4:2003 and ASTM D 6474-99. A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/L 2,6-Di tert butyl-4-methyl-phenol) as solvent at 160° C. and at a constant flow rate of 1 mL/min. 200 μl. of sample solution were injected per analysis. The column set was calibrated using universal calibration (according to ISO 16014-2:2003) with at least 15 narrow MWD polystyrene (PS) standards in the range from 0.5 kg/mol to 11 500 kg/mol. Mark Houwink constants for PS, PE and PP used are as described per ASTM D 6474-99. All samples were prepared by dissolving 5.0-9.0 mg of polymer in 8 mL (at 160° C.) of stabilized TCB (same as mobile phase) for 2.5 hours for PP or 3 hours for PE at max. 160° C. under continuous gentle shaking in the autosampler of the GPC instrument.

The xylene soluble fraction at room temperature (XS, wt.-%): The amount of the polymer soluble in xylene is determined at 25° C. according to ISO 16152; 5^{th} edition; 2005 Jul. 1.

### Gel index

The optical gel index was measured with an OCS gel counting apparatus consisting of a measuring extruder, attached to this were a chill roll unit, a heating and cooling unit (Haake C40P with a temperature range of 15-90° C.), a line camera (FS-5/4096 pixel for dynamic digital processing of grey tone images) and a winding unit (with automatic drawing control up to 10 N). The details of film production is listed below session.

For each material, the average number of gel dots on a film surface of 5 m² was detected by the line camera. The line camera was set to differentiate the gel dot size according to the following table:

| Gel dot size | Calculating Factor |
|---|---|
| up to 300 μm | ×0.1 |
| up to 600 μm | ×1.0 |
| up to 1000 μm | ×5.0 |
| >1000 μm | ×10.0 |

The number of gel dots detected for each size was multiplied with its respective calculating factor. The sum of all those values gave one final value, which is called the optical gel index.

### B. Examples

The catalyst used in the polymerization process for the inventive random propylene copolymer (R-PP) was Anti-dimethylsilanediyl[2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl] zirconium dichloride as disclosed in WO 2019/179959 A1 as MC-2. The supported metallocene catalyst was produced analogously to IE2 in WO 2019/179959 A1.

The catalyst used in the polymerization process for the comparative random propylene copolymer (R-PP2) was prepared as follows:

### Used Chemicals

20% solution in toluene of butyl ethyl magnesium (Mg(Bu)(Et), BEM), provided by Chemtura
2-ethylhexanol, provided by Amphochem
3-Butoxy-2-propanol-(DOWANOL™M PnB), provided by Dow
bis(2-ethylhexyl)citraconate, provided by SynphaBase
TiCl₄, provided by Millenium Chemicals
Toluene, provided by Aspokem
Viscoplex® 1-254, provided by Evonik
Heptane, provided by Chevron

### Preparation of a Mg Alkoxy Compound

Mg alkoxide solution was prepared by adding, with stirring (70 rpm), into 11 kg of a 20 wt-% solution in toluene of butyl ethyl magnesium (Mg(Bu)(Et)), a mixture of 4.7 kg of 2-ethylhexanol and 1.2 kg of butoxypropanol in a 20 1 stainless steel reactor. During the addition the reactor contents were maintained below 45° C. After addition was completed, mixing (70 rpm) of the reaction mixture was continued at 60° C. for 30 minutes. After cooling to room temperature 2.3 kg g of the donor bis(2-ethylhexyl)citraconate was added to the Mg-alkoxide solution keeping temperature below 25° C. Mixing was continued for 15 minutes under stirring (70 rpm).

### Preparation of Solid Catalyst Component

20.3 kg of TiCl₄ and 1.1 kg of toluene were added into a 201 stainless steel reactor. Under 350 rpm mixing and keeping the temperature at 0° C., 14.5 kg of the Mg alkoxy compound prepared in example 1 was added during 1.5 hours. 1.7 1 of Viscoplex® 1-254 and 7.5 kg of heptane were added and after 1 hour mixing at 0° C. the temperature of the formed emulsion was raised to 90° C. within 1 hour. After 30 minutes mixing was stopped catalyst droplets were solidified and the formed catalyst particles were allowed to settle. After settling (1 hour), the supernatant liquid was siphoned away. Then the catalyst particles were washed with 45 kg of toluene at 90° C. for 20 minutes followed by two heptane washes (30 kg, 15 min). During the first heptane wash the temperature was decreased to 50° C. and during the second wash to room temperature.

The thus obtained catalyst was used along with triethyl-aluminium (TEAL) as co-catalyst and dicyclopentyl dimethoxy silane (D-Donor) as donor.

The aluminium to donor ratio, the aluminium to titanium ratio and the polymerization conditions are indicated in table 1.

TABLE 1
Preparation of random propylene copolymers CE1 and IE1

| | |
|---|---|
| CE1 | IE1 |

Prepolymerization

| | | | |
|---|---|---|---|
| TEAL/Ti | [mol/mol] | 150 | n/a |
| TEAL/donor | [mol/mol] | 4.25 | n/a |
| Temperature | [° C.] | 30 | 20 |
| res. time | [h] | 0.35 | 0.32 |
| Donor | [—] | D | n/a |

Loop

| | | | |
|---|---|---|---|
| Temperature | [° C.] | 70 | 70 |
| Pressure | [kPa] | 5400 | 5400 |
| Split | [%] | 41 | 41 |
| H2/C3 ratio | [mol/kmol] | 0.6 | 0.05 |
| C2/C3 ratio | [mol/kmol] | 7.5 | 17.07 |
| C4/C3 ratio | [mol/kmol] | 0 | 39.61 |
| MFR₂ | [g/10 min] | 1.8 | 2.4 |
| XCS | wt.-%] | 5.2 | 1.2 |
| C2 | [mol-%] | 5.2 | 1.5 |
| C4 | [mol-%] | 0 | 3.8 |

GPR 1

| | | | |
|---|---|---|---|
| Temperature | [° C.] | 80 | 80 |
| Pressure | [kPa] | 2100 | 2100 |
| Split | [%] | 59 | 59 |
| H2/C3 ratio | [mol/kmol] | 5.8 | 2.4 |
| C2/C3 ratio | [mol/kmol] | 27 | 95 |
| C4/C3 ratio | [mol/kmol] | 0 | 47 |
| C2 | [mol-%] | 6.0 | 1.5 |
| C4 | [mol-%] | 0 | 4.6 |
| MFR₂ | [g/10 min] | 1.9 | 4.4 |

n/a: not applicable (for metallocene catalysts)

The polymers CE1 and IE1 have been mixed with 400 ppm calcium Stearate (CAS No. 1592-23-0) and 1,000 ppm Irganox B225 BASF AG, Germany.

In a second step CE1 has been visbroken by using a co-rotating twin-screw extruder at 200-230° C. and using an appropriate amount of (tert-butylperoxy)-2,5-dimethylhexane (Trigonox 101, distributed by Akzo Nobel, Netherlands) to achieve the target MFR₂. The properties of the pelletized, visbroken composition CE1 are given in Table 2.

The final properties of pelletized IE1 (which has not been visbroken) are likewise summarized in Table 2.

The pelletized IE1 and the pelletized, visbroken CE1 were used for preparing monolayer films using a cast film line.

The monolayer film before recycling was produced on a COEX Barmag 60 cast film line, with production rate of 60 kg/h, melt temperature 250° C., chill roll temperature of 25° C. The final film thickness is 70 μm and the width is 115 mm, having gel indexes as given in Table 2.

TABLE 2
Properties of the random propylene copolymers
(R-PP) and the monolayer polypropylene films.

| | |
|---|---|
| CE1 | IE1 |

Properties

| | | | |
|---|---|---|---|
| MFR₂ | [g/10 min] | 8.0 | 4.2 |
| XCS | [wt.-%] | 9.9 | 15.3 |
| Mz | [kg/mol] | 502.5 | 459.5 |
| Mw | [kg/mol] | 220.0 | 252.5 |
| Mz/Mw | [—] | 2.28 | 1.82 |
| 2.1 | [mol-%] | 0 | 0.25 |
| Gel index (of film) | [—] | 0.3 | 15.5 |

The monolayer films of CE1 and IE1 were subjected to a recycling process. In said recycling process the films were cut into pieces and recycled to pellets in a recycling machine.

The recycling of film were done on an Erema pilot line, type I_605K. It contains a preconditioning unit (PCU) and an extruder for melting and pelletization. The PCU is operated at 108-110° C., the extruder was running with screw speed of 220 U/min, melt temperature 176° C., and the production rate about 40 kg/h, the properties are given in Table 3.

The films were produced from the pellets of CE1 and IE1 received from recycling process. The films were produced on a OCS Measuring Extruder (ME25/5800 V3) supplied by Optical Control Systems GmbH. The melt temperature is 260° C., chill roll temperature 25° C., uptake speed of 3 m/min. The final film thickness is 70 and width is 1 m, having gel indexes as given in Table 3.

TABLE 3
Properties of the recycled polypropylene compositions
and the recycled polypropylene films.

| | |
|---|---|
| CE1 | IE1 |

Properties

| | | | |
|---|---|---|---|
| MFR₂ | [g/10 min] | 8.6 | 4.7 |
| XCS | [wt.-%] | 10.4 | 16.5 |
| Mz | [kg/mol] | 486.0 | 443.0 |
| Mw | [kg/mol] | 219.0 | 246.0 |
| Mz/Mw | [—] | 2.22 | 1.80 |
| Gel index (of film) | [—] | 77.0 | 16.3 |

Change relative to R-PP

| | | | |
|---|---|---|---|
| MFR₂ | [g/10 min] | +7.5% | +11.9% |
| XCS | [wt.-%] | +5.4% | +7.9% |
| Mz | [kg/mol] | −3.3% | −3.6% |
| Mw | [kg/mol] | −0.5% | −2.6% |
| Mz/Mw | [—] | −2.8% | −1.0% |
| Gel index (of film) | [—] | +25,600% | +5.2% |

As can be seen from Table 3, for both CE1 and IE1, the MFR₂ and XCS increase by a small amount, whilst the Mz, Mw and Mw/Mw decrease by a small amount. Most significantly, however, the gel index of the comparative, Ziegler-Natta catalyzed, example after recycling has increased from 0.3 to 77.0, which corresponds to an increase of over 25,000%, in contrast to the inventive, metallocene-catalyzed example, which only has an increase of approx. 5%.

It can be clearly seen that the inventive films are advantageous for use in mechanical recycling properties, with recycled films not exhibiting significant gel defects, which may seriously limit the application of the comparative films in such processes.

1. A process for forming a recycled polypropylene film, comprising the steps of:
(a) providing a monolayer polypropylene film comprising at least 90 wt. % of a random propylene copolymer (R-PP) based on the total weight of the monolayer polypropylene film having the following properties:
i) a melt flow rate (MFR2) measured according to ISO 1133 at 230° C. and 2.16 kg in the range from 2.0 to 20.0 g/10 min;
ii) a melting temperature (Tm) measured by differential scanning calorimetry (DSC) in the range from 120 to 150° C.;
iii) a total comonomer content, as determined by quantitative 13C-NMR spectroscopy analysis, in the range from 1.0 to 10.0 mol %, wherein the comonomer is selected from the group consisting of ethylene and C4 to C8 alpha olefins and combinations thereof;
iv) a content of 2,1-regiodefects, as determined by quantitative 13C-NMR spectroscopy analysis, in the range from 0.05 to 1.4 mol %;
(b) mechanically recycling the film of step (a), thereby obtaining a recycled polypropylene composition; and
(c) extruding the recycled polypropylene composition of step (b) to form a recycled polypropylene film.

2. The process according to claim 1, wherein the mechanical recycling of step (b) is carried out in a continuous melt-mixing device.

3. The process according to claim 1, wherein the random propylene copolymer (R-PP) has a molecular weight distribution (Mz/Mw), as determined by gel permeation chromatography (GPC), in the range from 1.10 to 2.10.

4. The process according to claim 1, wherein the random propylene copolymer (R-PP) has a xylene cold soluble content (XCS), as determined according to ISO 16152, in the range from 5 to 25 wt. %.

5. The process according to claim 1, wherein the random copolymer (R-PP) contains two comonomers.

6. The process according to claim 1, wherein the ratio of the MFR2 of the recycled polypropylene composition obtained in step (b) to the MFR2 of the random propylene copolymer (R-PP) of the monolayer polypropylene film provided in step (a), [MFR2(B)/MFR2(A)], is in the range from 1.00 to 1.30.

7. The process according to claim 1, wherein the ratio of the xylene cold soluble content (XCS), as determined according to ISO 16152, of the recycled polypropylene composition obtained in step (b) to the xylene cold soluble content (XCS), as determined according to ISO 16152, of the random propylene copolymer (R-PP) of the monolayer polypropylene film provided in step (a), [XCS(B)/XCS(A)], is in the range from 1.00 to 1.30.

8. The process according to claim 1, wherein the ratio of the weight average molecular weight (Mw), as determined by gel permeation chromatography (GPC), of the recycled polypropylene composition obtained in step (b) to the weight average molecular weight (Mw), as determined by gel permeation chromatography (GPC), of the random propylene copolymer (R-PP) of the monolayer polypropylene film provided in step (a), [Mw(B)/Mw(A)], is in the range from 0.90 to 1.00.

9. The process according to claim 1, wherein the ratio of the gel index, as measured on a 70 μm cast film sample, of the recycled polypropylene composition obtained in step (b) to the gel index, as measured on a 70 μm cast film sample, of random propylene copolymer (R-PP) of the monolayer polypropylene film provided in step (a), [gel index(B)/gel index(A)], is in the range from 1.00 to 1.50.

10. A recycled polypropylene film, comprising a recycled polypropylene composition having:
i) a melt flow rate (MFR2) measured according to ISO 1333 at 230° C. and 2.16 kg in the range from 2.0 to 20.0 g/10 min;
ii) a melting temperature (Tm) measured by differential scanning calorimetry (DSC) in the range from 120 to 150° C.;
iii) a total comonomer content, as determined by quantitative 13C-NMR spectroscopy analysis, in the range from 1.0 to 10.0 mol %, wherein the comonomer is selected from the group consisting of ethylene and C4 to C8 alpha olefins and combinations thereof; and
iv) a content of 2,1-regiodefects, as determined by quantitative 13C-NMR spectroscopy analysis, in the range from 0.05 to 1.4 mol %;
wherein the recycled polypropylene film has a gel index in the range from 16.0 to 50.0, as measured on a 70 μm film sample.

11. The recycled polypropylene film according to claim 10, wherein the recycled polypropylene film is obtainable via the process of claim 1.

12. (canceled)

13. (canceled)

14. The process according to claim 1, wherein the recycled polypropylene film of step c) is a recycled polypropylene cast film.

15. The process according to claim 1, wherein the mechanical recycling of step (b) is carried out in a continuous melt-mixing device at a temperature in the range from 170 to 270° C.
